(19) United States
(12) Patent Application Publication
(10) Pub. No.: US 2026/0138186 A1
(43) Pub. Date: May 21, 2026

(54) PREFERENTIAL HEATING OF WAX

(71) Applicant: Tritone Technologies Ltd., Rosh HaAyin (IL)

(72) Inventors: Ofer BEN-ZUR, Hod-HaSharon (IL); Boaz GLASS, Kfar Saba (IL)

(73) Assignee: Tritone Technologies Ltd., Rosh HaAyin (IL)

(21) Appl. No.: 19/389,103

(22) Filed: Nov. 14, 2025

Related U.S. Application Data
(60) Provisional application No. 63/720,802, filed on Nov. 15, 2024.

(51) Int. Cl. B22F 10/68; B22F 10/64; B33Y 40/20; F27B 17/00; F27D 5/00; H05B 3/00

(52) U.S. Cl. CPC B22F 10/68; B22F 10/64; B33Y 40/20; F27B 17/0016; F27D 5/00; H05B 3/0057

(57) ABSTRACT

Apparatus and method for removing wax from a complexly shaped product or part which is a mixture of wax and structural parts, includes: a support structure for holding the product, and an infra-red light source positioned in a first direction from the product or part. The infra-red lamp irradiates the product, melting the wax layer by layer. The layer of wax facing the light source melts and runs off and this is followed by the sequential melting of subsequent layers of wax as they become exposed. The melting thus occurs layer by layer before the heat reaches the interior of the product, thereby preventing the wax from expanding and causing cracks in the structural parts.

### RELATED APPLICATION

This application claims the benefit of priority under 35 USC § 119(e) of U.S. Provisional Ser. No. 63/720,802 filed on Nov. 15, 2024, the contents of which are incorporated by reference as if fully set forth herein in their entirety.

### FIELD AND BACKGROUND OF THE INVENTION

The present invention, in some embodiments thereof, relates to a method and apparatus for preferential heating of wax and, more particularly, but not exclusively, to the use of such a method during additive manufacture processes.

In additive manufacturing processes, the 3D printed product lies in a tray and forms a complete 3D volume. The volume is made up of wax and green parts, where the wax surrounds or supports material that enables the layers of green parts to form correctly. The green parts are the parts making up the structure of the product but prior to sintering.

At the point that all the layers have been added and the volume is complete, the green parts that make up the product or part itself need to be released from the wax. Typically therefore, there follows a stage of melting the wax and releasing the green parts.

Currently, the release process is performed by inserting the tray into an oven, and raising the internal temp to 80-100 Celsius, well above the 50 Celsius melting temp of the wax. The wax is gradually melted and flows away from the green parts.

The wax, typically paraffin wax, has a significantly higher thermal expansion coefficient as compared to the green parts, which at this point may essentially be a dried metal paste having a high heat conductivity. In general the heat conduction of the wax is very low and in specific geometries, such as tubular geometries for example, the internal volume of the green part is filled with a relatively large volume of wax.

As a result, during the melting process, the temperature of the wax inside the oven increases, but not fast enough to reach its melting temperature before expanding. As a result, wax in the interior expands. The expanded wax exerts pressure in its expanded state, and the pressure may continue to be exerted for a significant amount of time before the wax actually melts and runs away. As a result, the expanded wax, exerts pressure and may break the green parts.

### SUMMARY OF THE INVENTION

It is thus desirable to have a melting process in which the wax is gradually heated and then melted fast from one direction only, for example from the top of the tray downwards. Melting should desirably be fast enough that the wax layer melts before heat flows deep enough into the volume to cause expansion and as a result, leads to risk of cracking. In other words, wax at the top is heated, melts and drips away, then the wax below is heated, melted and drips away, and the process continues from the top of the volume downwards, such that at no time is there any significant volume of heated but unmelted wax. It is not possible to direct the heat in an oven since the oven chamber is specifically designed for uniform heating and the tray, with the wax and green parts, is heated from all directions.

The process is desirably planewise, in such a way that melting and heating occurs only from the top and gradually and uniformly downwards in the vertical direction.

It is noted that wax in general and paraffin wax in particular has an absorption peak between 800 and 3600 nm in the infrared spectrum. Metal and metal pastes have no, or very little, or relatively little, absorption at these wavelengths.

Accordingly, the idea is to irradiate the volume from above using an infrared lamp, in particular an infrared lamp that irradiates at the 800-3600 nm range. The effect is to melt the upper layer of the wax very quickly without much heat conduction into the volume of the wax. Then the melted wax drips away and the next layer is heated, thus saving on significant cracking effects.

According to an aspect of some embodiments of the present invention there is provided apparatus for removing wax from a complexly shaped product or part, the product or part comprising a mixture of wax and structural parts, the apparatus comprising:
a support structure for holding the product or part; and
an infra-red light source positioned in a first direction from the product or part; wherein the infra-red lamp is configured to irradiate the product from the first direction, causing the wax to melt layer by layer, such that a layer of wax facing the light source melts and runs off the product or part, followed by the sequential melting of subsequent layers of wax as the subsequent layers are exposed, thereby preventing the wax from expanding and causing cracks in the structural parts by ensuring the melting occurs layer by layer before the heat reaches the interior of the product.

Embodiments may include a tray to collect the melting wax.

In embodiments, the supporting structure is movable between an upper and a lower angle to aid the melting wax to flow from the product or part.

In embodiments, the supporting structure is supported on a first side by at least one vertical actuator, and on a second side is rotatably connected to an axle, the supporting structure thereby rotating about the axle when raised or lowered by the vertical actuator.

In embodiments, the supporting structure is held at four locations, at first and second locations by vertical actuators and rotatably at third and fourth locations by an axle.

In embodiments, the supporting structure comprises a turntable, the turntable being rotatable to rotate the product or part to aid the melting wax to flow from the product or part.

In embodiments, the first direction is vertical and the infra-red source is located above the product or part.

In embodiments, the infra-red light source is at least one infra-red lamp emitting infra-red light between 800 nm and 3600 nm.

In embodiments, the infra-red light source is at least one infra-red lamp emitting infra-red light at a wavelength selected for maximal absorption by the wax.

Embodiments may comprise a reflector about the infra-red sight source positioned to reflect light towards the product or part.

Embodiments may comprise a ventilation source for ventilating the product or part during operation of the infra-red light source.

Embodiments may comprise a housing to form an infra-red oven.

In embodiments, the product or part is located on the supporting structure.

According to a further aspect of the present invention there is provided a method for removing wax from a complexly shaped product or part, the product or part comprising a mixture of wax and structural parts, the method comprising:
irradiating the product or part from above using an infra-red light source, the infra-red light source being selected such that the wax has a higher heat absorption than the structural parts;
melting, using the irradiation, an exposed wax surface, thereby causing melted wax of the surface to run off the product; and
sequentially exposing subsequent layers of wax as previous layers run off, and causing the subsequent layers to melt and run off, thereby ensuring the melting occurs layer by layer before heat due to the irradiation reaches an interior of the product.

The method may comprise collecting the melting wax.

The method may comprise rocking the product or part between an upper and a lower angle to aid the melting wax to flow from the product or part.

The method may comprise rotating the product or part to aid the melting wax to flow from the product or part.

In embodiments of the method, the infra-red light source is at least one infra-red lamp emitting infra-red light between 800 nm and 3600 nm.

In embodiments of the method, the infra-red light source is at least one infra-red lamp emitting infra-red light at a wavelength selected for maximal absorption by the wax.

The method may comprise reflecting light towards the product or part from above.

The method may comprise concentrating light from the infra-red light source, thereby to avoid reflecting light towards the product or part from directions other than above.

The method may comprise ventilating the product or part during operation of the infra-red light source.

According to a yet further aspect of the present invention there is provided a method of manufacturing an oven for removal of wax from green structure of a part or product, the method comprising:
determining a wavelength or wavelength range at which the wax absorbs heat more strongly than the green structure;
providing a light source that irradiates at the determined wavelength or wavelength range;
providing a support structure for the product or part, to allow for placement of the product or part to be irradiated by the light source;
providing the support structure with mobility to rotate or tip the product or part during the irradiation.

The method may comprise providing a tray underneath the support structure to collect wax dripping from the product or part.

In the method, the mobility may be a rocking motion to rock the product or part.

In the method, the mobility may be a rotation to rotate the product or part to remove melting wax using centripetal force.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a view of a part that has failed during a conventional melting process;

FIG. 2 is a simplified isometric view of a melting apparatus according to embodiments of the present invention;

FIG. 3 is a front view of the apparatus of FIG. 2;

FIG. 4 is a longitudinal cross-section of the apparatus of FIG. 2;

FIG. 5 is a longitudinal cross-section of an embodiment of the apparatus of FIG. 2 in which the support structure is a turntable;

FIG. 6 is a perspective view of the apparatus of FIG. 5;

FIG. 7 is a simplified perspective view of an embodiment of the apparatus of FIG. 2 in which the support structure is held by actuators to rock the product back and forth;

FIG. 8 is a simplified graph of wavelength against absorption for paraffin wax;

FIG. 9 is a simplified flow chart showing operation of a melting procedure according to embodiments of the present invention; and

FIG. 10 is a simplified diagram showing a method of manufacture of an oven for melting of wax according to embodiments of the present invention.

### DESCRIPTION OF SPECIFIC EMBODIMENTS OF THE INVENTION

The present invention, in some embodiments thereof, relates to a method and apparatus for preferential melting of wax and, more particularly, but not exclusively, to the use of such a method during additive manufacture processes.

Apparatus and a method for removing wax from a complexly shaped product or part which is a mixture of wax and structural parts, according to embodiments of the present invention includes: a support structure for holding the product, and an infra-red light source positioned in a first direction from the product or part. The infra-red lamp irradiates the product, melting the wax layer by layer. The layer of wax facing the light source melts fast and runs off and this is followed by the sequential melting of subsequent layers of wax as they become exposed. The melting thus occurs from the outside in before the heat reaches the interior of the product, thereby preventing the wax from expanding and causing cracks in the structural parts.

As mentioned, wax, and paraffin wax in particular, has peaks in absorption at the 800 nm to 3600 nm wavelength range, whereas by contrast, metal paste has little or no absorption at this range, and indeed actually reflectis most of the energy). By operating an IR lamp above the tray, light at a wave range of 800 nm to 3600 nm is emitted, and the wax is immediately heated. The upper layer of wax then melts very fast, before any significant conduction continues into the body of the wax or through the green parts. The process continues and the melting process is performed top down. The outer layer of wax is melted before heat is conducted into deeper areas, avoiding expansion of significant volumes of wax

In addition, since the only heating mechanism is light emission, and the lamp is above the tray, there is no exposure of other surfaces of the tray. The only significant heat absorption is from above due to radiation from the lamps.

Due to the fact that no heat flows from the bottom or sides of the tray and the process is purely from top to bottom, the melting process mirrors the process in which the layers were built but in the opposite direction. This is believed to provide a more structurally true way of removing the wax.

Embodiments may include a ventilation source and vent the volume and immediate surrounding region to prevent the air around the tray from getting hot. Embodiments may also prevent light reflections from side elements from reaching the tray. Thus the heating in the system is substantially restricted to heating by radiation from above.

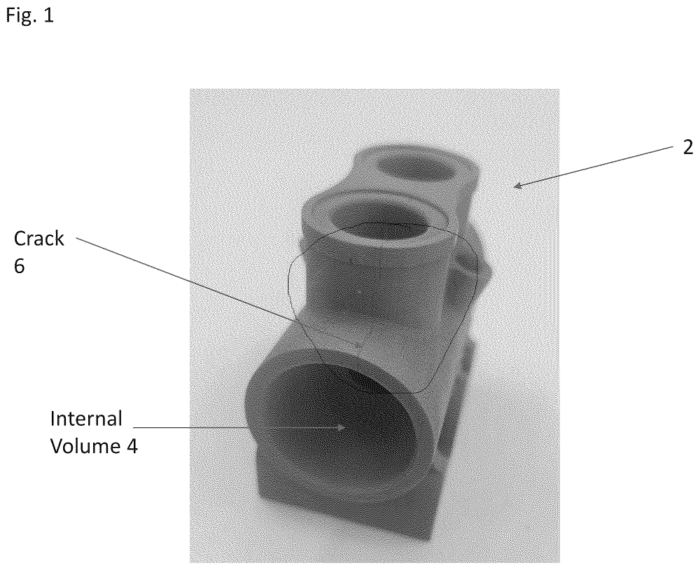

For purposes of better understanding some embodiments of the present invention, reference is first made to FIG. 1, which illustrates the cracking problem in a part having tubular construction. Specifically, FIG. 1 is a photo of a part 2 that has failed during a conventional melting process, due to formation of a crack in the green part.

Specifically, part 2 is of tubular construction, and in order to support the formation of a tubular structure during layerwise construction, the inner part 4 of the tube is filled with wax. The crack 6 was caused during melting the wax in a convection oven at 80 C, when the wax in the inner volume expanded gradually during heating, exerting forces on the part from the inside before the wax reached the melting temp.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

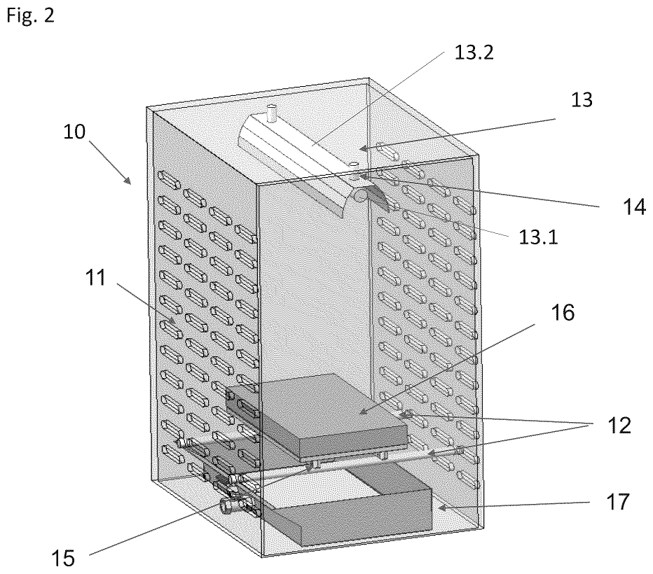

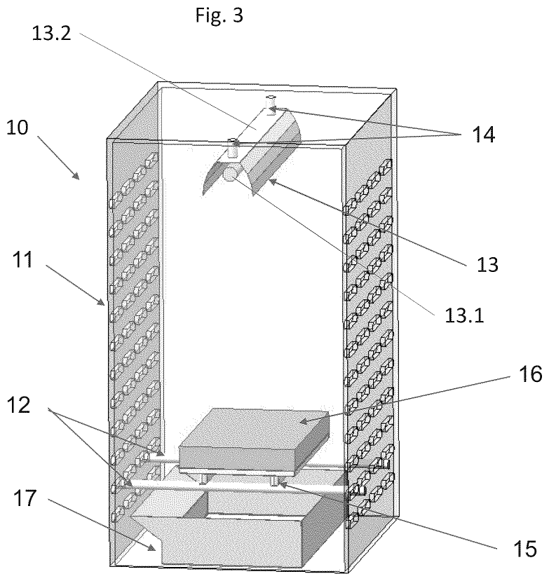

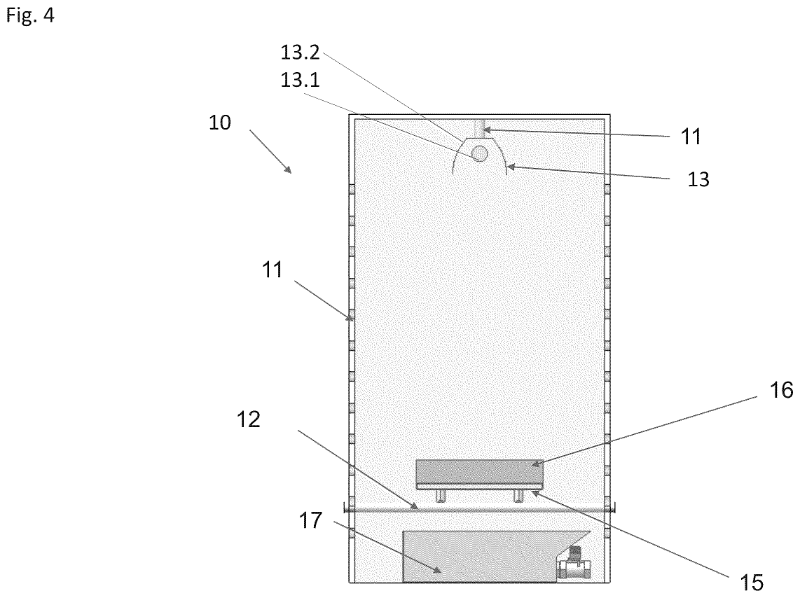

Referring now to the drawings, FIG. 2 is an isometric view of melting device 10 according to embodiments of the present invention, and FIG. 3 is a front perspective view of the same device. FIG. 4 is a longitudinal cross section from the front. Melting device 10 consists of box 11, for example built from metal panels so that it is not itself heated by the infra-red radiation from the lamps. Bars 12 extend between opposite walls of box 11 to support tray 15. On tray 15, is the build 16, which currently consists of both wax and green parts.

Infrared assembly 13, includes one or more IR lamps 13.1 and a reflector, and is suspended from rods 14 from the roof of box 11.

The infrared units may utilize infrared lamps having a radiation range that matches the wax absorption peaks. Thus for example, if the wax absorption peak is at a wave length of 2800 nanometer, then the IR lamp may advantageously have a spectrum around that peak.

Underneath tray 15 is a wax collection tray 17 which collects the melting wax flowing from the part 16.

The melted wax is collected in tray 17 and may be reused in the additive manufacture process as appropriate.

The absorption spectrum of the specific wax material in use may be measured using an FTIR test, well known to experts in the field, so that the infrared lamps may be correctly selected for the materials.

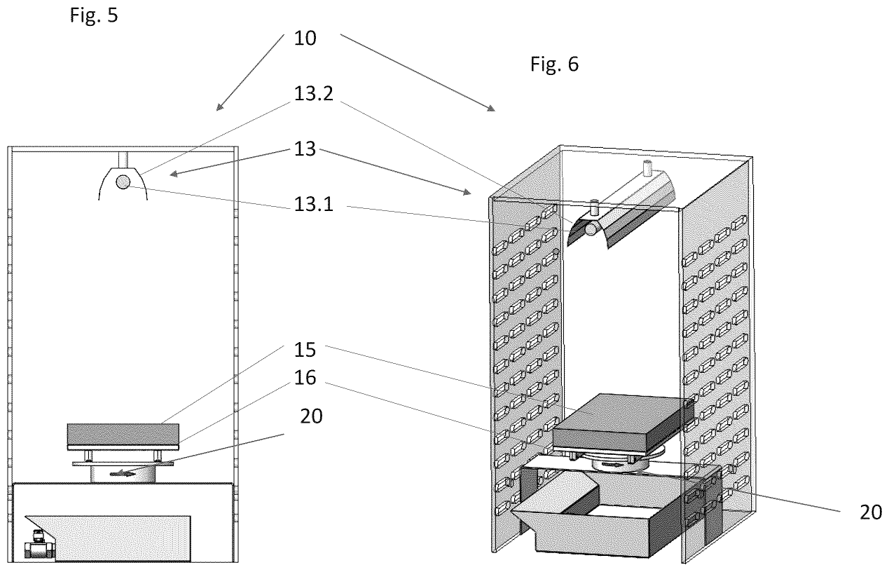

Reference is now made to FIGS. 5 and 6, which illustrate a further embodiment of the present invention. FIG. 5 is a longitudinal cross-section and FIG. 6. is an isometric view. FIGS. 5 and 6 show an embodiment of the melting device 10 with a motorized turntable 20. The motorized turntable 20 supports the tray 15 which carries the part 16. The turntable is rotatable, and rotating the tray 15 during melting using the turntable helps the melted wax to flow out of the built 16 more quickly and thus accelerates the melting process. Quickly removing the molted wax reduces the conductive and convective heat transfer from the hot melted fluid wax to the solid wax and green parts.

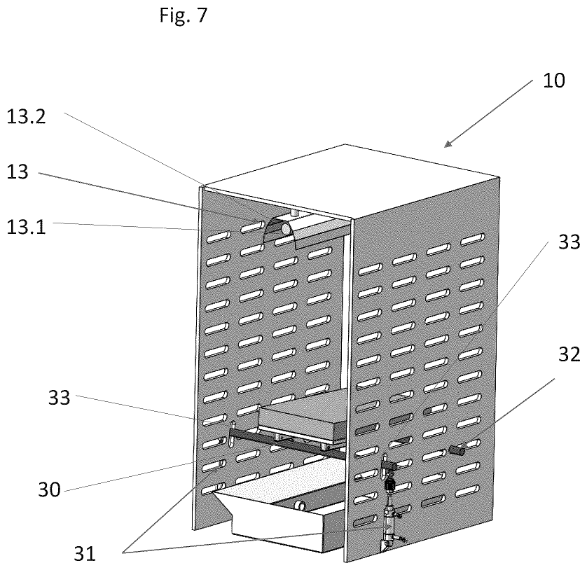

Reference is now made to FIG. 7 which is an isometric view of a further embodiment of the present invention. In FIG. 7, melting device 10 includes two actuators 31, for example pneumatic pistons, attached to either end of bar 30 that supports one side of the tray 15. Bar 30 is located at both end in slots 33 and the actuators 31 are attached to the bar on either side from outside of the slots 33. The other side of the tray 15 is held by axis 32. The actuators lift and lower one side of tray 15 between upper and lower angles, causing tray 15 to rotate about axis 32 during melting. The variably inclined orientation of tray 15 ensures that melted wax flows out of the part 16 to accelerate the melting process.

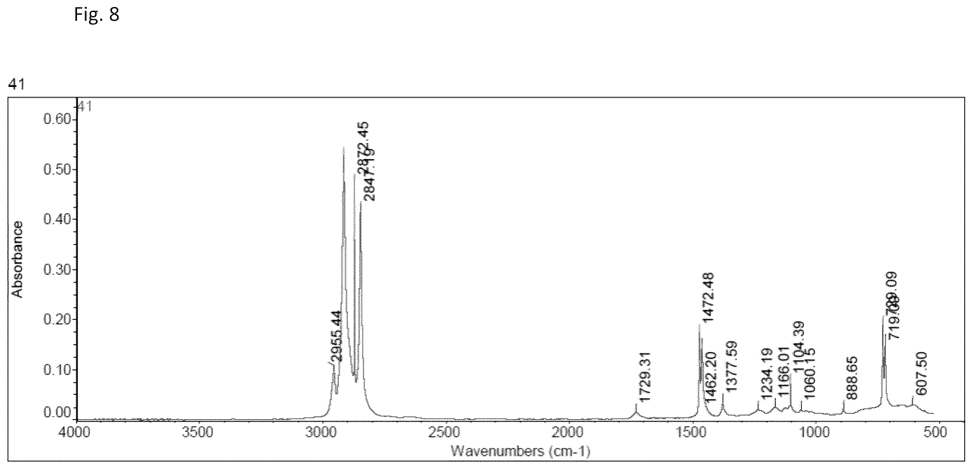

Reference is now made to FIG. 8, which is an example of an absorption spectrum of typical paraffin wax material. The main absorption peaks are at 1500 nm and at 2800 nm. Thus a medium wavelength range IR lamp will be suitable in such circumstances.

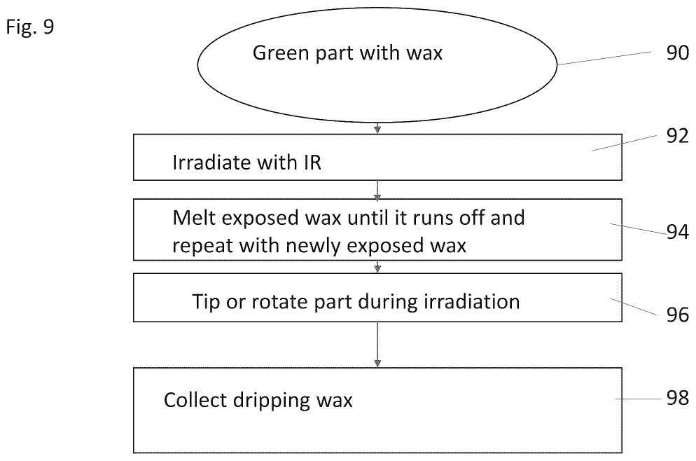

Reference is now made to FIG. 9, which shows a method for removing wax from a complexly shaped product or part-90, the product or part comprising a mixture of wax and structure, as discussed. The structure is typically still in the green state at this point. The method involves irradiating 92 the product or part from above using an infra-red light source. As explained the infra-red light source is chosen to have a wavelength in which the wax has a higher heat absorption than the structure.

The method continues by melting the top layer of wax so that the melted wax to run off the product; sequentially exposing subsequent layers of wax as previous layers run off, and causing the subsequent layers to melt and run off 94. The wax thus runs off before significant heat is conducted to the interior, preventing the wax from expanding and causing cracks in the structural parts.

The product may be held on a supporting structure and moved 96 during the irradiating process. The motion may be a rocking motion or a rotation, as discussed above. The method may further include collecting the dripping wax.

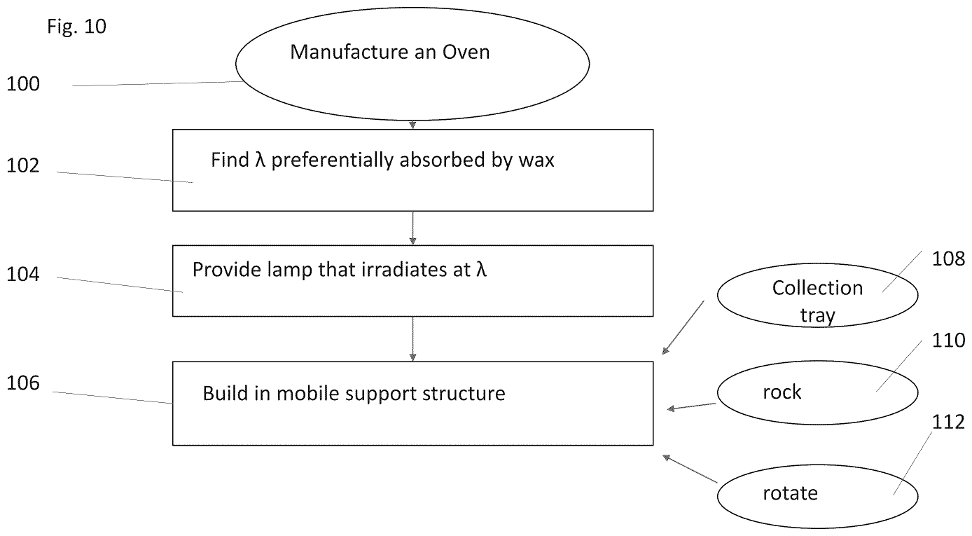

Reference is now made to FIG. 10, which illustrates a method of manufacture 100 of an oven or melting structure according to the present embodiments. Initially, a wavelength or wavelength range is obtained, 102, at the wax absorbs heat more strongly than the green structure. Typically, IR wavelengths are involved, and FIG. 8 shows the absorption chart for paraffin wax. The absorption spectrum of the specific wax material in use may be measured using a Fourier Transform InfraRed spectroscopy (FTIR) test. A light source that irradiates at the determined wavelength or wavelength range is inserted 104.

A support structure is then provided 106 to allow for placement of the product in a suitable position to be irradiated by the light source. Typically the light source irradiates from above and the product is held directly beneath the light source. The light source is designed to move the product during irradiation, either to rock the product back and forth 110 or to rotate the product 112, to assist the wax to fall away.

A collection tray may be installed under the support structure to collect the melting wax.

As mentioned above, embodiments may prevent IR radiation from reaching the product from the sides. In general, the IR lamp being used has a small light aperture to produce a relatively concentrated beam, and so the reflections from the walls do not hit the tray and the product. That is to say, radiation is concentrated so that only a very small fraction of the lamp power reaches the device walls in an optical path that would allow it to be reflected back to the wax.

### GENERAL

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise.

The terms “about”, “approximately” or “substantially” refer to 10% in either direction of a given value.

Throughout this application, various wavelengths in embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 500 to 4000 nm should be considered to have specifically disclosed subranges such as from 500 to 1000, from 2500 to 3000, from 750 to 3000, from 750 to 1500, from 1400 to 1500, from 2800 to 3000 etc., as well as individual numbers within that range. This applies regardless of the breadth of the range.

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. Apparatus for removing wax from a complexly shaped product or part, the product or part comprising a mixture of wax and structural parts, the apparatus comprising:
a support structure for holding said product or part; and
an infra-red light source positioned in a first direction from the product or part; wherein the infra-red lamp is configured to irradiate the product from said first direction, causing the wax to melt layer by layer, such that a layer of wax facing said light source melts and runs off the product or part, followed by the sequential melting of subsequent layers of wax as said subsequent layers are exposed, thereby preventing the wax from expanding and causing cracks in the structural parts by ensuring the melting occurs layer by layer before the heat reaches the interior of the product.

2. The apparatus of claim 1, further comprising a tray to collect said melting wax.

3. The apparatus of claim 1, wherein said supporting structure is movable between an upper and a lower angle to aid said melting wax to flow from said product or part.

4. The apparatus of claim 3, wherein said supporting structure is supported on a first side by at least one vertical actuator, and on a second side is rotatably connected to an axle, the supporting structure thereby rotating about said axle when raised or lowered by said vertical actuator.

5. The apparatus of claim 3, wherein said supporting structure is held at four locations, at first and second locations by vertical actuators and rotatably at third and fourth locations by an axle.

6. The apparatus of claim 1, wherein said supporting structure comprises a turntable, the turntable being rotatable to rotate the product or part to aid said melting wax to flow from said product or part.

7. The apparatus of claim 1, wherein said first direction is vertical and said infra-red source is located above said product or part.

8. The apparatus of claim 1, wherein the infra-red light source is at least one infra-red lamp emitting infra-red light between 800 nm and 3600 nm.

9. The apparatus of claim 1, wherein the infra-red light source is at least one infra-red lamp emitting infra-red light at a wavelength selected for maximal absorption by said wax.

10. The apparatus of claim 1, further comprising a reflector about said infra-red sight source positioned to reflect light towards said product or part.

11. The apparatus of claim 1, further comprising a ventilation source for ventilating said product or part during operation of said infra-red light source.

12. The apparatus of claim 1, further comprising a housing to form an infra-red oven.

13. The apparatus of claim 1, wherein said product or part is located on said supporting structure.

14. A method for removing wax from a complexly shaped product or part, the product or part comprising a mixture of wax and structural parts, the method comprising:
irradiating the product or part from above using an infra-red light source, the infra-red light source being selected such that the wax has a higher heat absorption than the structural parts;
melting, using said irradiation, an exposed wax surface, thereby causing melted wax of said surface to run off the product; and
sequentially exposing subsequent layers of wax as previous layers run off, and causing said subsequent layers to melt and run off, thereby ensuring the melting occurs layer by layer before heat due to said irradiation reaches an interior of the product.

15. The method of claim 14, further comprising collecting said melting wax.

16. The method of claim 14, comprising rocking said product or part between an upper and a lower angle to aid said melting wax to flow from said product or part.

17. The method of claim 14, comprising rotating the product or part to aid said melting wax to flow from said product or part.

18. The method of claim 14, wherein the infra-red light source is at least one infra-red lamp emitting infra-red light between 800 nm and 3600 nm.

19. The method of claim 14, wherein the infra-red light source is at least one infra-red lamp emitting infra-red light at a wavelength selected for maximal absorption by said wax.

20. The method of claim 14, further comprising reflecting light towards said product or part from above.

21. The method of claim 20, further comprising concentrating light from said infra-red light source, thereby to avoid reflecting light towards said product or part from directions other than above.

22. The method of claim 14, further comprising ventilating said product or part during operation of said infra-red light source.

23. A method of manufacturing an oven for removal of wax from green structure of a part or product, the method comprising:
determining a wavelength or wavelength range at which said wax absorbs heat more strongly than said green structure;
providing a light source that irradiates at said determined wavelength or wavelength range;
providing a support structure for said product or part, to allow for placement of said product or part to be irradiated by said light source;
providing said support structure with mobility to rotate or tip said product or part during said irradiation.

24. The method of manufacturing of claim 23, further comprising providing a tray underneath said support structure to collect wax dripping from said product or part.

25. The method of manufacturing of claim 23, wherein said mobility is a rocking motion to rock said product or part.

26. The method of manufacturing of claim 23, wherein said mobility is a rotation to rotate said product or part to remove melting wax using centripetal force.
